(19) United States
(12) Patent Application Publication
(10) Pub. No.: US 2018/0182539 A1
(43) Pub. Date: Jun. 28, 2018

(54) SURFACE-MOUNT INDUCTOR

(71) Applicant: Murata Manufacturing Co., Ltd., Kyoto (JP)

(72) Inventors: Keita MUNEUCHI, Nagaokakyo-shi (JP); Eiji ISO, Nagaokakyo-shi (JP); Hideaki OOI, Nagaokakyo-shi (JP)

(73) Assignee: Murata Manufacturing Co., Ltd., Kyoto (JP)

(21) Appl. No.: 15/844,757

(22) Filed: Dec. 18, 2017

(30) Foreign Application Priority Data
Dec. 22, 2016 (JP) 2016-249649

(51) Int. Cl. H01F 27/29; H01F 27/28; H01F 27/255

(52) U.S. Cl. CPC H01F 27/292; H01F 27/255; H01F 27/2828

(57) ABSTRACT

A surface-mount inductor includes a coil formed by winding a conductor, a molded body made of a sealing material containing a metal magnetic material and a resin with the coil enclosed therein, and an external terminal connected to the coil. The molded body has two parallel surfaces and has, in at least one of the surfaces, a first region having a filling factor of the metal magnetic material higher than an average filling factor of the metal magnetic material in the whole of the molded body. The external terminal is disposed on a region at least including the first region.

### CROSS-REFERENCE TO RELATED APPLICATIONS

This application claims priority to Japanese Patent Application No. 2016-249649, filed on Dec. 22, 2016, the disclosure of which is hereby incorporated by reference in its entirety.

### TECHNICAL FIELD

The present disclosure relates to a surface-mount inductor.

### BACKGROUND

In a conventional surface-mount inductor, a coil is formed by winding a conductive wire, and the coil is buried in a molded body formed of a sealing material containing a resin and a magnetic powder such that a lead-out end part of the coil is connected to an external terminal formed on a surface of the molded body (see, e.g., Japanese Laid-Open Patent Publication No. 2005-116708). In this surface-mount inductor, a molded body having a coil incorporated therein is formed by a compression molding method or a powder compacting method, and an external terminal is formed by applying a conductive paste to this molded body.

For the conductive paste, a paste containing metal fine particles with a particle diameter smaller than 100 nm is used for forming the external terminal (see, e.g., Japanese Laid-Open Patent Publication No. 2013-211333). In such a conventional surface-mount inductor, since the metal fine particles constituting the conductive paste are sintered at a low temperature, it is considered that bonding between the conductive wire and the external terminal becomes favorable and can improve initial resistance.

To improve adhesion strength between the molded body and the external terminal, a smoothness is reduced on a surface at least partly on a portion where an external electrode is formed on a molded body formed to enclose a coil and at least partially expose both end portions of the coil on the surface thereof, as compared to a smoothness of a surface therearound, and an external electrode conductive with the coil is formed on the portion with the reduced smoothness (see, e.g., Japanese Laid-Open Patent Publication No. 2014-225590).

Furthermore, in a conventional surface-mount inductor, the resin on the surface of the molded body is removed to expose a metal magnetic powder on the surface of the molded body, and a plating is grown on the portion with the exposed metal magnetic powder so as to form the external terminal (see, e.g., Japanese Laid-Open Patent Publication No. 2016-058418).

### SUMMARY

A first aspect of the present disclosure provides a surface-mount inductor that includes a coil formed by winding a conductor, a molded body made of a sealing material containing a metal magnetic material and a resin with the coil enclosed therein, and an external terminal connected to the coil. The molded body has two parallel surfaces and has, in at least one of the surfaces, a first region having a filling factor of the metal magnetic material higher than an average filling factor of the metal magnetic material in the whole of the molded body. The external terminal is disposed on a region at least including the first region.

A second aspect of the present disclosure provides a surface-mount inductor that includes a coil formed by winding a conductor, a molded body made of a sealing material containing a metal magnetic material and a resin with the coil enclosed therein, and an external terminal connected to the coil. The molded body has two parallel surfaces and has, in at least one of the surfaces, a third region having a center particle diameter D50 of the metal magnetic material larger than a center particle diameter D50 of the metal magnetic material in the whole of the molded body. The external terminal is disposed on a region at least including the third region.

### BRIEF DESCRIPTION OF THE DRAWINGS

FIG. 1 is a perspective view of a molded body of a first example of a surface-mount inductor.

FIG. 2 is a partial cross-sectional view of FIG. 1.

FIG. 3 is a schematic cross-sectional view of a structure of a surface region of the molded body in the surface-mount inductor.

FIG. 4 is a perspective view for explaining manufacturing steps of the surface-mount inductor.

FIG. 5 is a perspective view for explaining other manufacturing steps of the surface-mount inductor.

FIG. 6 is a schematic cross-sectional view of a structure of a surface region of a molded body in a second example of the surface-mount inductor.

FIG. 7 is a partial cross-sectional view of a third example of the surface-mount inductor.

### DETAILED DESCRIPTION

In the surface-mount inductor described in Japanese Laid-Open Patent Publication No. 2005-116708, since the bonding between the conductive wire and the external terminal is weak, the initial resistance is high, and the bonding between the conductive wire and the external terminal may become unstable. In the surface-mount inductor described in Japanese Laid-Open Patent Publication No. 2013-211333, the adhesion strength between the molded body containing the resin and the external terminal is weak, and the external terminal may easily peel off from the molded body due to thermal shock. Furthermore, the conductive paste using metal fine particles with minute particle diameter is expensive and the manufacturing cost tends to increase. The surface-mount inductor described in Japanese Laid-Open Patent Publication No. 2014-225590 has a problem that it is necessary to add a step of reducing the surface smoothness of the portion provided with the external electrode, which accordingly increases the cost. In the surface-mount inductor described in Japanese Laid-Open Patent Publication No. 2016-058418, since the molded body and the external terminal are in contact with each other, the resin on the surface must be increased in thickness so as to sufficiently maintain the insulation of the molded body. In this case, the resin must sufficiently be removed by lengthening a time of laser irradiation or increasing a laser irradiation output so as to expose the metal magnetic powder on the surface of the molded body, and it is concerned that this maybe accompanied by a damage on the molded body or a deterioration in bonding strength of a plating deposition interface.

The present disclosure provides an inexpensive surface-mount inductor having high insulation and capable of improving adhesion strength between a molded body and an external terminal.

A first aspect of the present disclosure provides a surface-mount inductor that includes a coil formed by winding a conductor, a molded body made of a sealing material containing a metal magnetic material and a resin with the coil enclosed therein, and an external terminal connected to the coil. The molded body has two parallel surfaces and has, in at least one of the surfaces, a first region having a filling factor of the metal magnetic material higher than an average filling factor of the metal magnetic material in the whole of the molded body. The external terminal is disposed on a region at least including the first region.

A second aspect of the present disclosure provides a surface-mount inductor that includes a coil formed by winding a conductor, a molded body made of a sealing material containing a metal magnetic material and a resin with the coil enclosed therein, and an external terminal connected to the coil. The molded body has two parallel surfaces and has, in at least one of the surfaces, a third region having a center particle diameter D50 of the metal magnetic material larger than a center particle diameter D50 of the metal magnetic material in the whole of the molded body. The external terminal is disposed on a region at least including the third region.

The inductor of the present disclosure is a surface-mount inductor that includes a coil formed by winding a conductor, a molded body made of a sealing material containing a metal magnetic material and a resin with the coil enclosed therein, and an external terminal connected to the coil. The molded body has two parallel surfaces and has, in at least one of the surfaces, a first region having a filling factor of the metal magnetic material higher than an average filling factor of the metal magnetic material in the whole of the molded body. The external terminal is disposed on a region at least including the first region, and therefore, the inductor can improve the adhesion strength between the molded body and the external terminal while having high insulation for the whole of the molded body.

The inductor of the present disclosure is a surface-mount inductor that includes a coil formed by winding a conductor, a molded body made of a sealing material containing a metal magnetic material and a resin with the coil incorporated therein, and an external terminal connected to the coil. The molded body has two parallel surfaces and has, in at least one of the surfaces, a third region having a center particle diameter D50 of the metal magnetic material larger than a center particle diameter D50 of the metal magnetic material in the whole of the molded body. The external terminal is disposed on a region at least including the third region, and therefore, the inductor can improve the adhesion strength between the molded body and the external terminal while having high insulation for the whole of the molded body.

A surface-mount inductor includes a coil formed by winding a conductor, a molded body with the coil sealed by a sealing material mainly containing a metal magnetic material and a resin, and an external terminal connected to the coil. The molded body has two parallel surfaces, and at least one surface side thereof is provided with a first region having a filling factor of the metal magnetic material higher than a filling factor of the metal magnetic material in the other portion of the molded body. Therefore, the filling factor of the metal magnetic material in the first region is larger than the filling factor of the metal magnetic material in the whole of the molded body. In the molded body, a plurality of metal magnetic materials different in center particle diameter D50 is used as the metal magnetic material, and at least one surface side of the two parallel surfaces of the molded body is provided with a third region having a higher ratio of a metal magnetic material with a large particle diameter as compared to the other portion of the molded body. Therefore, the center particle diameter D50 of the metal magnetic material contained in the third region is larger than the center particle diameter D50 of the metal magnetic material in the whole of the molded body. The external terminal is formed on the molded body and located in a region including at least the first region or the third region and is connected to the coil.

The first region and the third region of the molded body have insulation resistance lower than the other region of the molded body. Therefore, in the molded body of the surface-mount inductor, a portion with high insulation resistance and a portion with low insulation resistance are intentionally formed. Thus, the insulation resistance can be made higher around the coil inside the molded body and the insulation resistance can be made lower in a portion where the external terminal is formed on the surface side of the molded body. This enables a configuration of a surface-mount inductor with improved adhesion strength between the molded body and external terminals while maintaining high insulation. The portion with low insulation resistance is the first region having a higher filling factor of the metal magnetic material, or the third region having a larger center particle diameter D50 of the metal magnetic material contained therein, as compared to the portion with high insulation resistance. The region having a higher filling factor of the metal magnetic material can be configured such that the center particle diameter D50 of the metal magnetic material contained therein becomes larger, for example. The portion with a larger center particle diameter D50 of the metal magnetic material can be configured such that the content ratio of the metal magnetic material having a large particle diameter becomes larger than the content ratio of the metal magnetic material having a small particle diameter, for example.

The molded body may have a second region having a density of the metal magnetic material lower than the first region, or a fourth region having a center particle diameter D50 smaller than the third region, adjacent to a peripheral portion of the incorporated coil, preferably, in contact with an outer surface of the coil. By providing a region with high insulation resistance adjacent to the peripheral portion of the coil, the surface-mount inductor can exhibit excellent insulation performance.

The surface of the molded body with the first region or the third region formed therein is at least one of the two parallel surfaces of the molded body and may be a surface extending in a direction orthogonal to the coil axis of the incorporated coil. As a result, when the surface-mount inductor is formed, for example, by pressure molding, the deformation of the coil is suppressed and the productivity is further improved.

The external terminal may be formed by at least partially removing the resin on the surface in the first region or the third region of the molded body, bonding the metal magnetic material exposed on the surface of the molded body to a plating layer constituting the external terminal, and connecting the external terminal and the lead-out end part of the coil. Since the resin on the surface is at least partially removed and the metal magnetic material is exposed, the formation of the plating layer more easily proceeds and the productivity is improved. Additionally, since the plating layer is improved in adhesiveness to the molded body, the strength between the molded body and the external electrode is improved. Furthermore, the first region or the third region with the external terminal formed therein has a higher filling factor of the metal magnetic material and/or contains a larger amount of the metal magnetic material with a large particle diameter and therefore has a relatively small content of the resin. Thus, the resin on the surface of the molded body can be removed in a short time by using a lower power laser, for example.

The first region and/or the third region may be disposed at least on a substrate mounting surface side of the surface-mount inductor. By disposing the region on the substrate mounting surface side, the first region and/or the third region can more easily be formed and the productivity is further improved.

The filling factor of the metal magnetic material in the molded body is measured as follows . A cross section of the molded body is observed with a scanning electron microscope (SEM) to make a calculation based on a ratio of the occupation area of the metal magnetic material to an area of an observation region and the specific gravity of the metal magnetic material.

The center particle diameter D50 of the metal magnetic material is a particle diameter corresponding to 50% volume accumulation from the small diameter side in the particle diameter distribution. The center particle diameter D50 of the metal magnetic material in the molded body can be measured as follows. A cross section of the molded body is observed with a scanning electron microscope (SEM) to calculate respective circle equivalent diameters of observed metal magnetic materials. The acquired circle equivalent diameters are used as the particle diameters of the metal magnetic materials to create a volume-based particle diameter distribution. The particle diameter at 50% volume accumulation from the small diameter side in the particle diameter distribution is defined as the center particle diameter D50.

### Examples

Embodiments of the present disclosure will now be described with reference to the drawings. It is noted that the embodiments described below exemplify the surface-mount inductor for embodying the technical ideas of the present disclosure and that the present disclosure does not limit the surface-mount inductor to the following. The members described in claims are not limited to the members of the embodiments. Particularly, dimensions, materials, shapes, relative arrangements, etc. of constituent components described in the embodiments are not intended to limit the scope of the present disclosure only thereto unless otherwise specifically described and are merely illustrative examples. In the figures, the same portions are denoted by the same reference numerals. In consideration of facilitation of description or understanding of the main points, embodiments are separately described for convenience; however, configurations shown in different embodiments can partially be substituted or combined. In the second and subsequent embodiments, the details in common with the first example will not be described, and only different points will be described. Particularly, the same actions and effects from the same configurations will not individually be referred to in each embodiment.

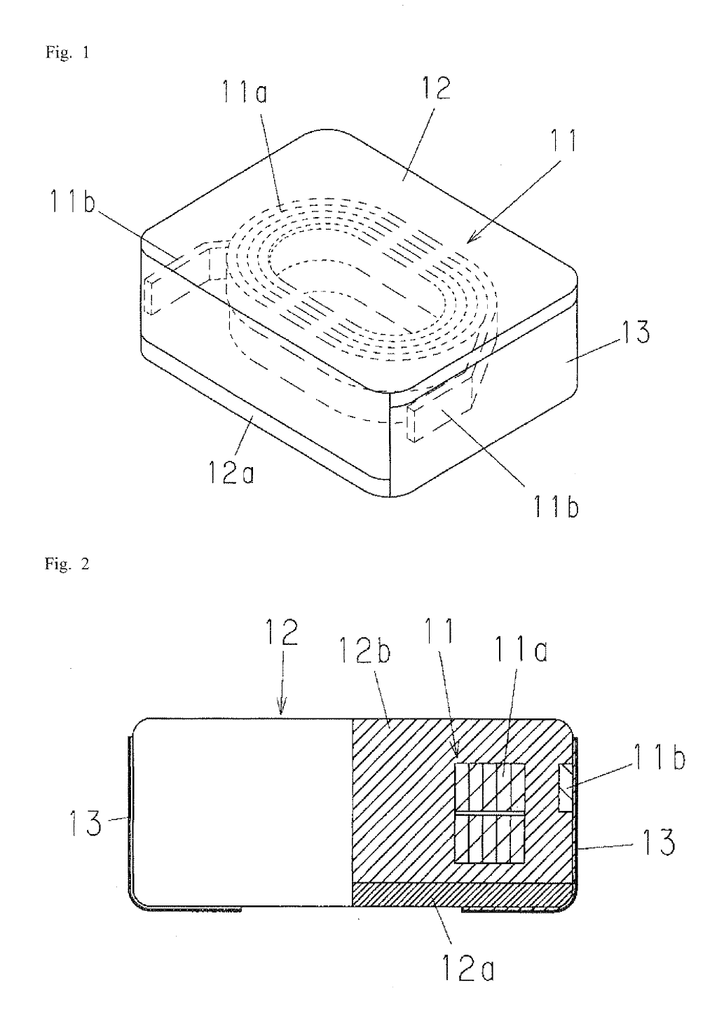

FIG. 1 is a perspective view of a surface-mount inductor of a first example of the present disclosure, and FIG. 2 is a partial cross-sectional view of FIG. 1. In FIGS. 1 and 2, 11 denotes a coil, and 12 denotes a molded body.

In FIG. 1, the coil 11 is formed as an air core coil including a winding part 11a in which a conductor is spirally wound in outside-to-outside manner in two tiered such that both end portions thereof are located on the outer circumference, and lead-out end parts 11b led out from the winding part 11a. For the conductor, for example, a rectangular wire having a rectangular cross section is used. For the lead-out end parts 11b, both end portions of the conductor forming the coil are each led out from the winding part 11a to face each other across the winding part 11a.

In FIGS. 1 and 2, the molded body 12 is formed to enclose the coil 11 by using a sealing material containing a resin and a metal magnetic material. The molded body 12 has two surfaces in respective planes extending in directions orthogonal to a coil axis and formed in parallel with each other, longitudinal-direction side surfaces in respective planes extending in directions parallel to the coil axis and orthogonal to a longitudinal direction of the molded body 12, and lateral-direction side surfaces in respective planes extending in directions parallel to the coil axis and orthogonal to the longitudinal-direction side surfaces. One of the surfaces in a plane extending in a direction orthogonal to the coil axis is the substrate mounting surface. For the sealing material, for example, an iron-based metal magnetic powder and an epoxy resin are used as the metal magnetic material and the resin, respectively, and a mixture thereof is used. The molded body 12 has a substrate mounting surface side (also referred to as a bottom surface side) provided with a first region 12a having a filling factor of the metal magnetic material higher than a filling factor of the metal magnetic material in the other portion of the molded body. A peripheral portion of the coil 11 is provided with a second region 12b having a filling factor of the metal magnetic material lower than the filling factor of the metal magnetic material in the first region 12a. The second region 12b is disposed in contact with at least an outer surface of the coil 11 and can surround the winding part 11a. Surfaces of the lead-out end parts 11b of the coil 11 are exposed on the longitudinal-direction side surfaces of the molded body 12.

External terminals 13 are each formed over the longitudinal-direction side surface and the bottom surface of the molded body 12 so as to have a portion located at least on the first region 12a, and the lead-out end part 11b of the coil 11 and the external terminal 13 are connected. The external terminal 13 is formed of a plating layer using a metallic material such as Ni and Sn into an L shape.

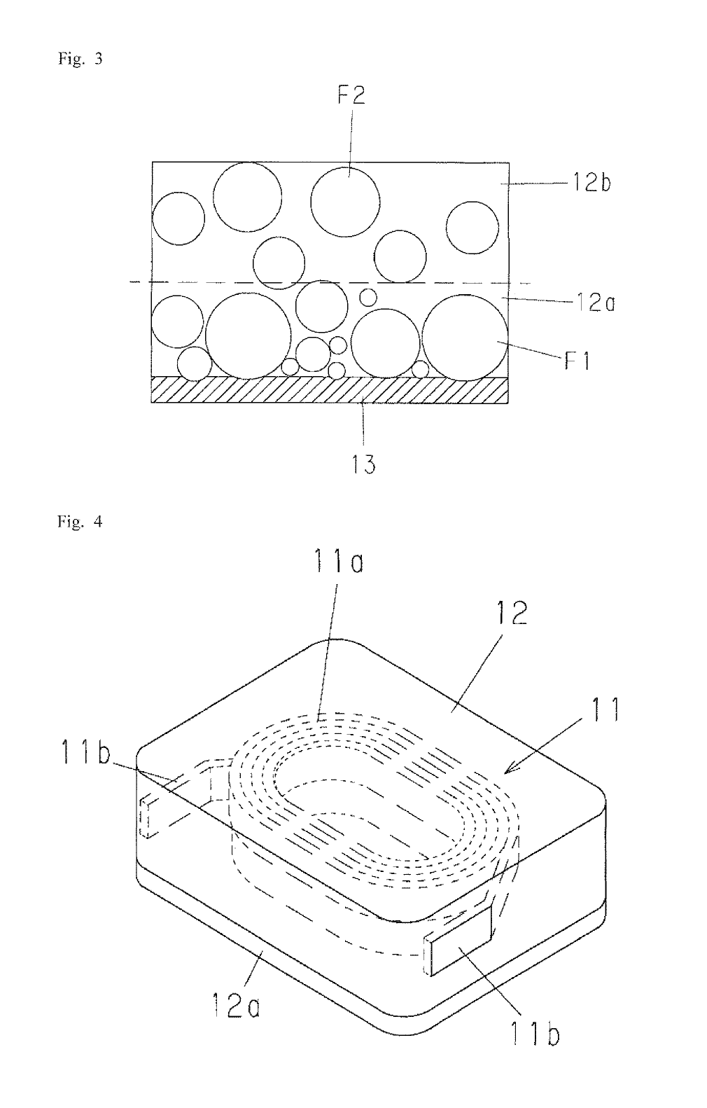

In the surface-mount inductor, as shown in FIG. 2, the region 12a and the region 12b are formed in the molded body 12, and the external terminal 13 is formed to cover at least a portion of the surface of the region 12a of the molded body 12 and the lead-out end part 11b. FIG. 3 is a schematic cross-sectional view of a relationship of the region 12a, the region 12b, and the external terminal 13 in the vicinity of the substrate mounting surface of the molded body 12. In FIG. 3, a filling factor of a metal magnetic powder F1 in the region 12a is higher than a filling factor of a metal magnetic powder F2 in the region 12b. The region 12a is formed at a predetermined thickness over the entire bottom surface of the molded body 12 with the other portion defined as the region 12b, and the coil 11 is incorporated in the region 12b. Therefore, the insulation of the portion other than the entire bottom surface of the molded body 12 becomes higher, and the insulation of the entire bottom surface of the molded body 12 becomes lower. In this state, when the molded body 12 is plated after exposing the metal magnetic powder F1 by removing the resin component on the surface of the portion of the molded body 12 where the external terminal 13 is formed, the deposition of the plating is facilitated in the portion with lower insulation resistance due to the metal magnetic powder F1 exposed on the bottom surface of the molded body 12 as compared to the other portion. Since the plating is bonded and deposited to the metal magnetic powder F1, the adhesion strength between the external terminal 13 and the molded body 12 is improved. Furthermore, since the insulation resistance of the bottom surface of the molded body 12 is made lower in advance as compared to the other portion, i.e., the filling factor of the metal magnetic powder is made higher, energy for removing the resin component on the surface to expose the metal magnetic powder can be reduced.

The surface-mount inductor as described above maybe manufactured as follows. First, after the winding part 11a is formed by spirally winding a conductor having a rectangular cross section with insulating coating in outside-to-outside manner in two tiered such that both ends thereof are located on the outer circumference, both ends of the conductor are led out from the outer circumference of the winding part 11a to form the lead-out end parts 11b so that the coil 11 is formed. For the conductor used in this example, a conductor having an imide-modified polyurethane layer as an insulating film was used. The insulating film may be polyamide-based or polyester-based, and a film having a high heat resistance temperature is more preferable. Although the conductor having a rectangular cross section is used in this example, a conductor having a round cross section or a conductor having a polygonal cross section may be used. Although the coil 11 is formed into an elliptical shape when viewed in the coil axis direction in FIG. 4, the shape of the coil 11 is not limited to the elliptical shape.

By using a sealing material acquired by using, for example, an iron-based metal magnetic powder and an epoxy resin as the metal magnetic material and the resin, respectively, and granulating a mixture thereof into a powdered state, the molded body 12 with the coil 11 buried therein as shown in FIG. 4 is molded by a molding method such as a compression molding method, a sheet construction method, and a powder compacting method. In the case of the compression molding method, the molded body 12 is formed by adding, to a bottom surface of a temporary molded body holding the coil 11, a temporary molded body having a filling factor higher than a filling factor of the metal magnetic powder of the temporary molded body, or by filling a lower layer portion or an upper layer portion in a mold with a material having a filling factor higher than the filling factor of the metal magnetic powder of the temporary molded body. In the case of the sheet construction method, the molded body 12 is formed by adding to an uppermost layer or a lowermost layer of the molded body a metal magnetic sheet having a filling factor higher than the filling factor of the metal magnetic powder of the other layer. In the case of the powder compacting method, the molded body 12 is formed by filling a lower layer portion or an upper layer portion in a mold with a material having a filling factor higher than the filling factor of the metal magnetic powder of the other portion. The lead-out end part 11b of the coil 11 is led out such that the surface thereof is exposed at a position where the external terminal is formed on the longitudinal-direction side surface of the molded body 12.

In the molded body 12 with the coil 11 incorporated therein in this way, as shown in FIG. 2, the bottom surface side is provided with the first region 12a having a filling factor of the metal magnetic material higher than a filling factor of the metal magnetic material in the other portion of the molded body, and the peripheral portion of the coil 11 is provided with the second region 12b having a filling factor of the metal magnetic material lower than the filling factor of the metal magnetic material in the first region 12a.

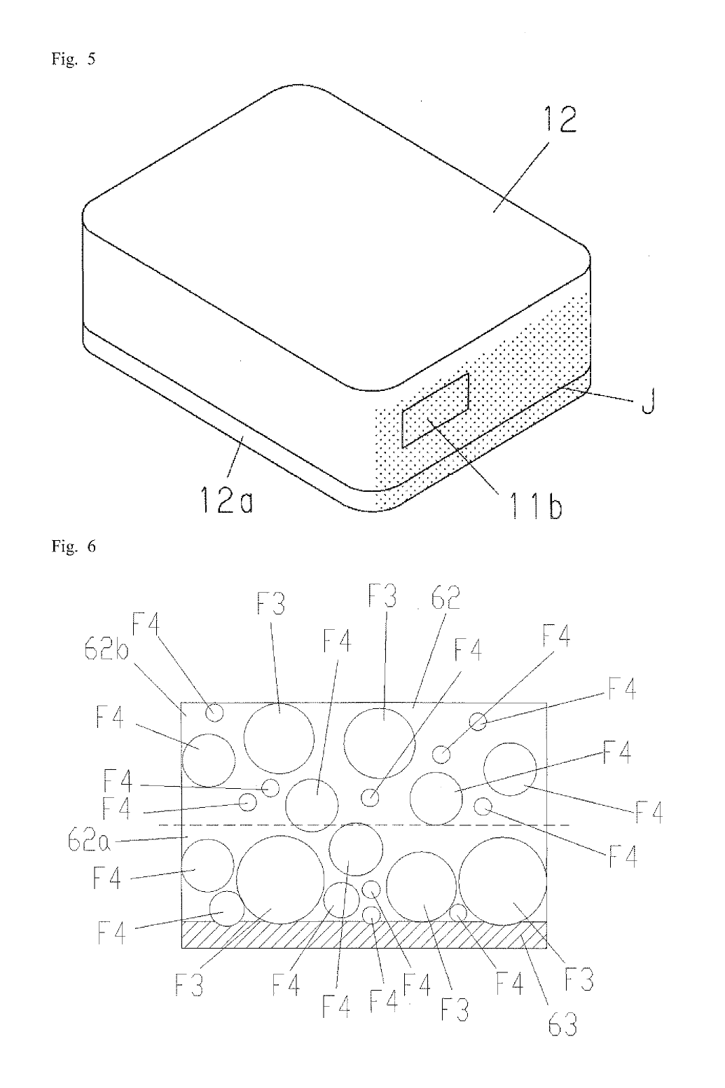

Subsequently, after removing the insulating film on the surface of the lead-out end part 11b of the coil 11 by mechanical peeling, as shown in FIG. 5, a laser irradiation, blasting treatment, polishing, etc. are applied to a portion J where the external terminal is formed on the longitudinal-direction side surface and the bottom surface of the molded body 12, so as to remove the resin component etc. present on the surface thereof. As a result, the surface of the metal magnetic powder constituting the molded body 12 is exposed.

The molded body 12 is further subjected to plating with a conductive material to form a plating layer bonded to the metal magnetic powder on the longitudinal-direction side surface and the bottom surface (the substrate mounting surface) of the molded body 12 as shown in FIGS. 1 and 2 so that the external terminal 13 is formed. For the conductive material, for example, a material containing Ni or Sn or a material containing both thereof is used. The external terminal 13 is connected to the lead-out end part 11b of the coil 11 exposed on the longitudinal-direction side surface of the molded body 12.

FIG. 6 is a schematic cross-sectional view of a relationship of a third region 62a, a fourth region 62b, and an external terminal 63 in the vicinity of the substrate mounting surface of a molded body 62 in a second example of the surface-mount inductor of the present disclosure.

In this example, as in the first example described above, the molded body 62 encloses a coil including a winding part in which a conductor is spirally wound in outside-to-outside manner in two tiered such that both end portions thereof are located on the outer circumference and lead-out end parts led out from the winding part. The molded body 62 is formed to have two parallel surfaces by using a plurality of metal magnetic materials different in center particle diameter D50 as the metal magnetic material in addition to a resin, such that at least one surface side of the surfaces is provided with the third region 62a having a larger ratio of a metal magnetic material F3 with a large particle diameter as compared to the other portion of the molded body 62, while a peripheral portion of the coil is adjacently provided with the fourth region 62b having a larger ratio of a metal magnetic material F4 with a small particle diameter as compared to the third region 62a of the molded body. Therefore, the molded body 62 has the two parallel surfaces and has, in at least one of the surfaces, the third region 62a having the center particle diameter D50 of the metal magnetic material larger than the center particle diameter D50 of the metal magnetic material in the whole of the molded body 62. The surface of the lead-out end part of the coil is exposed on the longitudinal-direction side surface of the molded body 62.

External terminals 63 are each formed over the longitudinal-direction side surface and the bottom surface of the molded body 62 so as to have a portion located at least on the third region 62a, and the lead-out end part of the coil and the external terminal 63 are connected. The external terminal 63 is formed of a plating layer using a metallic material such as Ni and Sn into an L shape.

In the surface-mount inductor formed in this way, as in the first example, the insulation of the portion other than the entire bottom surface of the molded body 62 becomes higher, and the insulation of the entire bottom surface of the molded body 62 becomes lower. In this state, when the molded body 62 is plated after exposing the metal magnetic powder by removing the resin component on the surface of the portion of the molded body 62 where the external terminal 63 is formed, the deposition of the plating is facilitated in the portion with lower insulation resistance due to the metal magnetic powder exposed on the bottom surface of the molded body 62 as compared to the other portion. Since the plating is bonded and deposited to the metal magnetic powder, the adhesion strength between the external terminal 63 and the molded body 62 is improved. Furthermore, since the insulation resistance of the bottom surface of the molded body 62 is made lower in advance as compared to the other portion, i.e., the ratio of the metal magnetic powder F3 with a large particle diameter is made relatively larger so that the center particle diameter D50 of the metal magnetic material is increased, energy for removing the resin component on the surface to expose the metal magnetic powder can be reduced.

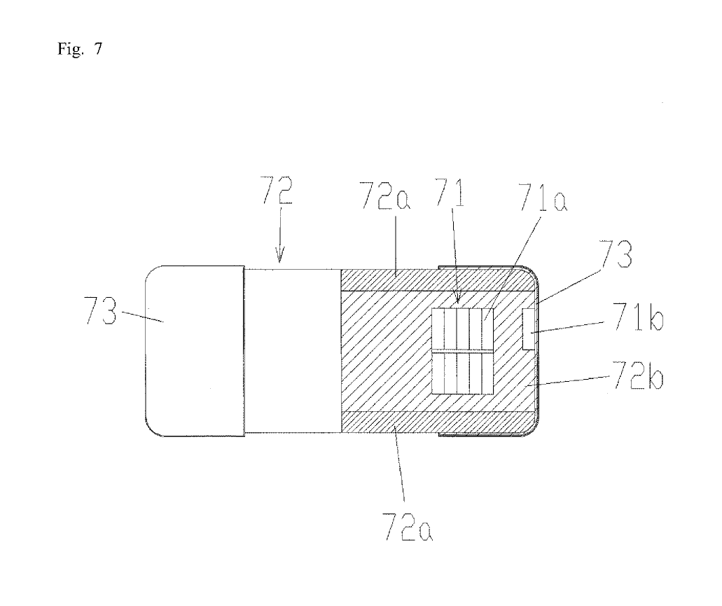

FIG. 7 is a partial cross-sectional view of a third example of the surface-mount inductor. A coil 71 is formed as a coil including a winding part 71a in which a conductor is spirally wound in outside-to-outside manner in two tiered such that both end portions thereof are located on the outer circumference and lead-out end parts 71b led out from the winding part 71a. For the conductor, a rectangular wire having a rectangular cross section is used. For the lead-out end parts 71b, both end portions of the conductor are led out from the winding part 71a to face each other across the winding part 71a.

The molded body 72 is formed to enclose the coil 71 by using a sealing material containing a resin and a metal magnetic material. For the sealing material, for example, an iron-based metal magnetic powder and an epoxy resin are used as the metal magnetic material and the resin, respectively, and a mixture thereof is used. The molded body 72 has the bottom surface side and the upper surface side provided with a first region 72a having a filling factor of the metal magnetic material higher than a filling factor of the metal magnetic material inside the molded body. A peripheral portion of the coil 71 is provided with a second region 72b having a density of the metal magnetic material lower than the filling factor of the metal magnetic material in the first region 72a. The second region 72b is disposed in contact with at least an outer surface of the coil 71. Surfaces of the lead-out end parts 71b of the coil 71 are exposed on the longitudinal-direction side surfaces of the molded body 72.

External terminals 73 are each formed over the longitudinal-direction side surface of the molded body 72 and partially over four surfaces adjacent to the side surface, and the lead-out end part 71b of the coil 71 and the external terminal 73 are connected. The external terminal 73 is formed of a plating layer formed by removing the resin component on the surface of the portion of the molded body 72 where the external terminal is formed, so as to expose the metal magnetic powder, and applying plating with a metal material such as Ni and Sn.

Although the examples of the surface-mount inductor of the present disclosure have been described, the present disclosure is not limited to these examples. For example, the external terminals may be formed by using a conductive paste. Even in this case, the contact area with the metal magnetic powder in the first region and/or the third region becomes larger than the conventional case obviously when the resin component is removed by laser irradiation etc. on the surface of the portion of the molded body where the external terminal is formed, so as to expose the metal magnetic powder, as well as when such a treatment is not applied, and therefore, the adhesion strength between the molded body and the external terminal can be improved. Although the first region and/or the third region is formed on the whole of the bottom surface or the upper surface in the examples, the region may be formed in a portion of the corresponding surface. In this case, the region may be formed in the portion of the corresponding surface where the external terminal is formed.

It is to be understood that although the present disclosure has been described with regard to preferred embodiments thereof, various other embodiments and variants may occur to those skilled in the art, which are within the scope and spirit of the disclosure, and such other embodiments and variants are intended to be covered by the following claims.

All publications, patent applications, and technical standards mentioned in this specification are herein incorporated by reference to the same extent as if each individual publication, patent application, or technical standard was specifically and individually indicated to be incorporated by reference.

What is claimed is:

1. A surface-mount inductor comprising:
a coil formed by winding a conductor;
a molded body made of a sealing material containing a metal magnetic material and a resin with the coil enclosed therein; and
an external terminal connected to the coil, wherein
the molded body has two parallel surfaces and has, in at least one of the surfaces, a first region having a filling factor of the metal magnetic material higher than an average filling factor of the metal magnetic material in the whole of the molded body, and
the external terminal is disposed on a region of the molded body at least including the first region.

2. The surface-mount inductor according to claim 1, wherein the molded body has, at least adjacent to a peripheral portion of the coil, a second region having a filling factor of the metal magnetic material lower than the filling factor of the metal magnetic material in the first region.

3. The surface-mount inductor according to claim 2, wherein the second region is disposed in contact with an outer surface of the coil.

4. The surface-mount inductor according to claim 1, wherein
a plating layer bonding to the metal magnetic material is included in a region from which the resin is at least partially removed in the first region, wherein
the plating layer constitutes the external terminal, and wherein
the external terminal is connected to the lead-out end part of the coil.

5. The surface-mount inductor according to claim 2, wherein
a plating layer bonding to the metal magnetic material is included in a region from which the resin is at least partially removed in the first region, wherein
the plating layer constitutes the external terminal, and wherein
the external terminal is connected to the lead-out end part of the coil.

6. The surface-mount inductor according to claim 3, wherein
a plating layer bonding to the metal magnetic material is included in a region from which the resin is at least partially removed in the first region, wherein
the plating layer constitutes the external terminal, and wherein
the external terminal is connected to the lead-out end part of the coil.

7. The surface-mount inductor according to claim 1, wherein the first region is included on a substrate mounting surface side.

8. The surface-mount inductor according to claim 2, wherein the first region is included on a substrate mounting surface side.

9. The surface-mount inductor according to claim 3, wherein the first region is included on a substrate mounting surface side.

10. The surface-mount inductor according to claim 4, wherein the first region is included on a substrate mounting surface side.

11. A surface-mount inductor comprising:
a coil formed by winding a conductor;
a molded body made of a sealing material containing a metal magnetic material and a resin with the coil enclosed therein; and
an external terminal connected to the coil, wherein
the molded body has two parallel surfaces and has, in at least one of the surfaces, a third region having a center particle diameter D50 of the metal magnetic material larger than a center particle diameter D50 of the metal magnetic material in the whole of the molded body, and
the external terminal is disposed on a region of the molded body at least including the third region.

12. The surface-mount inductor according to claim 11, wherein in a peripheral portion of the coil in the molded body, the surface-mount inductor has a fourth region having a center particle diameter D50 smaller than the center particle diameter D50 of the third region.

13. The surface-mount inductor according to claim 12, wherein the fourth region is disposed in contact with an outer surface of the coil.

14. The surface-mount inductor according to claim 11, wherein
a plating layer bonding to the metal magnetic material is included in a region from which the resin is at least partially removed in the third region, wherein
the plating layer constitutes the external terminal, and wherein
the external terminal is connected to the lead-out end part of the coil.

15. The surface-mount inductor according to claim 12, wherein
a plating layer bonding to the metal magnetic material is included in a region from which the resin is at least partially removed in the third region, wherein
the plating layer constitutes the external terminal, and wherein
the external terminal is connected to the lead-out end part of the coil.

16. The surface-mount inductor according to claim 13, wherein
a plating layer bonding to the metal magnetic material is included in a region from which the resin is at least partially removed in the third region, wherein
the plating layer constitutes the external terminal, and wherein
the external terminal is connected to the lead-out end part of the coil.

17. The surface-mount inductor according to claim 11, wherein the third region is included on a substrate mounting surface side.

18. The surface-mount inductor according to claim 12, wherein the third region is included on a substrate mounting surface side.

19. The surface-mount inductor according to claim 13, wherein the third region is included on a substrate mounting surface side.

20. The surface-mount inductor according to claim 14, wherein the third region is included on a substrate mounting surface side.
